(19) United States
(12) Patent Application Publication
(10) Pub. No.: US 2026/0119333 A1
(43) Pub. Date: Apr. 30, 2026

(54) DATA STORAGE DEVICE, DATA STORAGE SYSTEM AND DATA BACKUP METHOD USING THE SAME

(71) Applicant: Samsung Electronics Co., Ltd., Suwon-si (KR)

(72) Inventors: Sang-Ho YI, Suwon-si (KR); Youngseol KIM, Suwon-si (KR); Kyungduk LEE, Suwon-si (KR)

(21) Appl. No.: 19/357,895

(22) Filed: Oct. 14, 2025

(30) Foreign Application Priority Data
Oct. 29, 2024 (KR) 10-2024-0150033

(51) Int. Cl. G06F 11/14; G06F 12/02

(52) U.S. Cl. CPC G06F 11/1458; G06F 12/023; G06F 2201/805

(57) ABSTRACT

The present disclosure relates to data storage devices, data storage systems, and data backup methods. An example data storage device includes a first-type memory, a second-type memory including a plurality of sectors that are units to which data is assigned, and a processor configured to back up the data which is entered in at least one idle sector among the plurality of sectors into the first-type memory.

### CROSS-REFERENCE TO RELATED APPLICATION

This application claims the benefit of Korean Patent Application No. 10-2024-0150033, filed on Oct. 29, 2024, in the Korean Intellectual Property Office, the disclosure of which is incorporated herein by reference in its entirety.

### BACKGROUND

A non-volatile memory (NVM) is a memory in which entered data remains even if power is shut down and may be quickly recovered to be in a recent status even in an event such as a sudden power shutdown. The non-volatile memory is used to store a file or process a task. Particularly, the non-volatile memory may be used as a persistent secondary storage and used to back up data in an intermediate storage device such as a volatile memory (e.g., dynamic random access memory).

Meanwhile, when the data in the intermediate storage device is backed up into the persistent secondary storage due to a shutdown of power of a device, a backup time is increased in proportion to a data amount of the intermediate storage device.

### SUMMARY

The present disclosure relates to a data storage device, a data storage system, and a data backup method using the same for decreasing a backup data amount at a time of whole backup by backing up in advance a portion of data stored in a volatile memory into a non-volatile memory before a whole backup event occurs.

However, the goals to be achieved by example implementations of the present disclosure are not limited to the objectives described above and other objects may be clearly understood from the following example implementations.

In general, according to some aspects, a data storage device includes a first-type memory, a second-type memory including a plurality of sectors and a processor configured to back up data from at least one idle sector of the plurality of sectors into the first-type memory.

The processor may be configured to back up the data into the first-type memory based on at least one of an idle count or a status value of each sector of the plurality of sectors.

The status value of a sector may be based on at least one of the idle count of the sector or whether the data is stored in the sector.

A unit count of the idle count of each sector of the plurality of sectors may be increased at intervals of a counter period.

The status value may include a first status value of the sector corresponding to a first status in which the data is not stored in the sector, a second status value corresponding to a second status in which the data is stored in the sector, or a third status value corresponding to a third status in which the data in the sector is backed up into the first-type memory.

The status value of an active sector having the second status value may be set to the third status value based on the data in the active sector being backed up into the first-type memory.

Based on the data being stored in a target sector having the second status value, the idle count of the target sector may be configured to be initialized.

The idle sector may be a sector of which the at least one idle count is greater than or equal to a threshold value among a second plurality of sectors having the second status value.

The processor may be configured to back up the data into the first-type memory based on the at least one idle sector being identified, the at least one idle sector being identified based on the at least one of the idle count or the status value of the at least one idle sector.

The processor may be configured to identify a whole backup event, and back up the data into the first-type memory based on the whole backup event, the data being stored in a sector having the second status value.

The whole backup event may include at least one of a non-volatile memory express shutdown notification event, a compute express link global persistent flush event, and a power shutdown event.

The processor may be configured to sequentially back up the data into a plurality of logical addresses of the first-type memory, and read, based on a recovery event, the data in reverse order or recover a sector corresponding to the read data among the plurality of sectors, and the status value of the recovered sector may be configured to be set to a second status value.

The first-type memory may be a non-volatile memory, and the second-type memory may be a volatile memory.

In general, according to some aspects, a data backup method by a data storage device includes identifying at least one of an idle count or a status value of each sector of a plurality of sectors of a second-type memory, the at least one of the idle count or the status value being stored in a counter circuit, identifying at least one idle sector among the plurality of sectors, and backing up data from the at least one idle sector into a first-type memory.

The status value of a sector may include a first status value corresponding to a first status in which the data is not stored in the sector, a second status value corresponding to a second status in which the data is stored in the sector, or a third status value corresponding to a third status in which the data in the sector is backed up into the first-type memory.

The data backup method may include initializing the status value of an active sector having the second status value set to the third status value based on the data in the active sector being backed up into the first-type memory.

The data backup method may include initializing the idle count of a target sector based on the data being stored in the target sector having the second status value.

The identifying the at least one idle sector may include identifying the idle count of a target sector having the second status value among the plurality of sectors, and identifying the target sector as the idle sector based on the identified idle count being greater than or equal to a threshold value.

The backing up may include backing up the data into the first-type memory based on a whole backup event the data being stored in a sector having the second status value among the plurality of sectors.

The data backup method may include sequentially backing up the data into a plurality of logical addresses of the first-type memory, reading the data in reverse order based on a recovery event in the data storage device, and recovering a sector corresponding to the read data among the plurality of sectors, and the status value of the recovered sector may be set to a second status value.

In general, according to some aspects, a data storage system includes a first-type memory, a second-type memory including a plurality of sectors, a host configured to receive a first instruction on at least one of a data entering operation, a data reading operation, a whole backup operation, or a data recovery operation, and a backup controller configured to back up the data based on at least one of an idle count or a status value of each sector of the plurality of sectors, the data being stored in at least one sector of the plurality of sectors, and the status value is determined based on a second instruction on at least one of the data entering operation or the whole backup operation.

Additional aspects of example implementations will be set forth in part in the description which follows and, in part, will be apparent from the description.

According to example implementations, when a whole backup event occurs, it is possible to decrease an amount required for backup and a time required for the backup by backing up in advance some data of data in a memory, which satisfies a set condition.

Effects of the present disclosure are not limited to those described above and other effects may be made apparent to those skilled in the art from the following description of the accompanying claims.

### BRIEF DESCRIPTION OF THE DRAWINGS

These and/or other aspects, features, and advantages of the present disclosure will become apparent and more readily appreciated from the following description of example implementations, taken in conjunction with the accompanying drawings.

FIG. 1 is a diagram illustrating an example of an environment for implementing a data backup method.

FIGS. 2 and 3 are block diagrams illustrating an example of a data storage device.

FIG. 4 is a diagram of an example of a status value of a sector.

FIG. 5 is a flowchart illustrating an example of a data backup method.

FIGS. 6A, 6B, 6C, 6D, 6E, 6F, and 6G are diagrams describing an example of an operation performed by a data storage device.

FIG. 7 is a diagram for describing an example of an operation performed by a data storage system.

FIG. 8 is a diagram for describing an example of an operation performed by a data storage device.

FIGS. 9A, 9b, and 9C are diagrams describing an example of an operation performed by a data storage device.

FIG. 10 is a diagram for describing an example of an operation performed by a data storage system.

FIG. 11 is a block diagram illustrating an example of a backup controller.

### DETAILED DESCRIPTION

Terms used in the example implementations are selected, as much as possible, from general terms that are widely used at present while taking into consideration the functions obtained in accordance with the present disclosure, but these terms may be replaced by other terms based on intentions of those skilled in the art, customs, emergence of new technologies, or the like. Also, in a particular case, terms that are arbitrarily selected by the applicant of the present disclosure may be used. In this case, the meanings of these terms may be described in corresponding description parts of the disclosure. Accordingly, it should be noted that the terms used herein should be construed based on practical meanings thereof and the whole content of this specification, rather than being simply construed based on names of the terms.

In the entire specification, when an element is referred to as “including” another element, the element should not be understood as excluding other elements so long as there is no special conflicting description, and the element may include at least one other element. In addition, the terms “unit” and “module”, for example, may refer to a component that exerts at least one function or operation, and may be realized in hardware or software, or may be realized by combination of hardware and software.

In the following description, example implementations of the present disclosure will be described in detail with reference to the accompanying drawings so that those skilled in the art can easily carry out the present disclosure. However, the present disclosure may be implemented in many different forms and is not limited to the example implementations described herein.

Hereinafter, the example implementations of the present disclosure will be described with reference to the accompanying drawings.

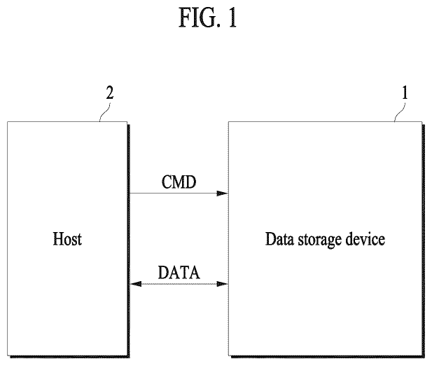

FIG. 1 is a diagram illustrating an example of an environment for implementing a data backup method.

Referring to FIG. 1, the environment for implementing the data backup method according to example implementations may include a data storage device (hereinafter referred to as “device”) 1 and a host 2. An implemented example of the device 1 may be applied to a large-capacity storage device such as a hard disk drive, a solid state disk, and a flash memory. In addition, the host 2 may be a physical or logical portion of the device 1 or may be a device (e.g., a computing device or the like) that is present outside a device 1.

In some implementations, the device 1 may perform an operation corresponding to an instruction CMD while performing data communication with the host 2.

In some implementations, the host 2 may transmit the instruction CMD on at least one or more of a data entering operation, a data reading operation, a whole backup operation, and a data recovery operation. In other words, the device 1 may receive the instruction CMD on the at least one or more of the data entering operation, the data reading operation, the whole backup operation, and the data recovery operation from the host 2.

For example, when receiving the instruction CMD on the data entering operation from the host 2, the device 1 may enter data DATA corresponding to the instruction CMD in a memory in the device 1. In addition, when receiving the instruction CMD on the data reading operation from the host 2, the device 1 may read or transmit the data DATA corresponding to the instruction CMD in the memory in the device 1 to the host 2. Also, when receiving the instruction CMD on the whole backup operation from the host 2, the device 1 may back up all data entered in the memory in the device 1 into another memory in the device 1. At this point, as an example, the device 1 may perform backup based on a status value determined based on the instruction CMD on at least one or more of the data entering operation, the whole backup operation, and the data recovery operation.

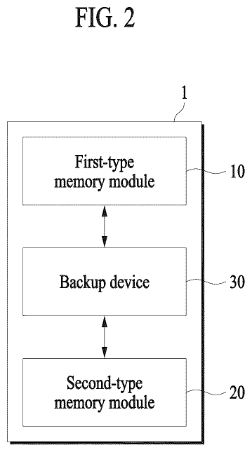

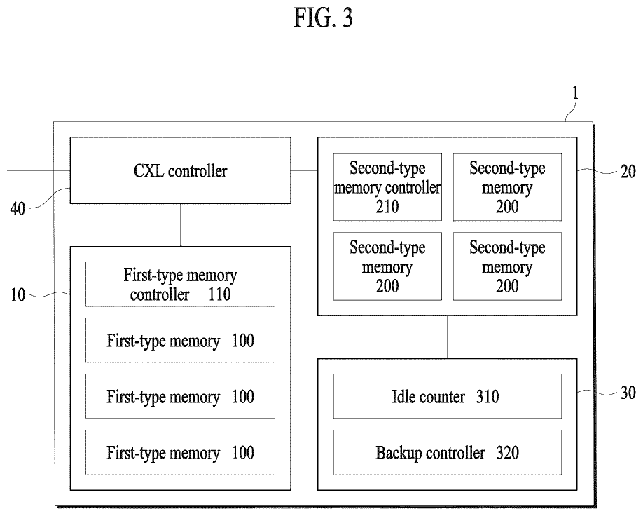

FIGS. 2 and 3 are block diagrams illustrating an example of a data storage device.

Referring to FIG. 2, the device 1 may include a first-type memory module 10, a second-type memory module 20, and a backup device 30.

In some implementations, the first-type memory module 10 may include one or more first-type memories 100 and further include a first-type memory controller 110. FIG. 3 illustrates that the first-type memory module 10 includes three first-type memories 100 and one first-type memory controller 110. However, the first-type memory module 10 may not necessarily include the first-type memory controller 110. The first-type memory module 10 which is described in the present disclosure may be a first-type memory 100 itself, and the number of the first-type memories 100 may not be limited to three.

In some implementations, the first-type memory 100 may be a non-volatile memory. For example, the first-type memory 100 may be a phase-change random access memory (PRAM), a magnetoresistive random access memory (MRAM), a ferroelectric random access memory (FeRAM), and/or a resistive random access memory (RRAM).

In some implementations, the second-type memory module 20 may include one or more second-type memories 200 and further include a second-type memory controller 210. FIG. 3 illustrates that the second-type memory module 20 includes three second-type memories 200 and one second-type memory controller 210. However, the second-type memory module 20 may not necessarily include the second-type memory controller 210. The second-type memory module 20 which is described in the present disclosure may be a second-type memory 200 itself, and the number of the second-type memories 200 may not be limited to three.

In some implementations, the second-type memory 200 may be a volatile memory. For example, the second-type memory 200 may be a dynamic random access memory (DRAM) and/or a static random access memory (SRAM). The second-type memory 200 may be used to store short-term data not expected to be stored for a long time, such as a temporary file and local data that are copied from another storage location.

In some implementations, the first-type memory controller 110 and the second-type memory controller 210 may perform a function for communication with an external device (e.g., the above-described host). For example, the first-type memory controller 110 and the second-type memory controller 210 may control the first-type memory 100 and the second-type memory 200 by receiving an instruction or data transmitted to each of the first-type memory module 10 and the second-type memory module 20 from the external device and may transmit a result of operations of the first-type memory module 10 and the second-type memory module 20, which correspond to the instruction, to the external device. That is, the first-type memory controller 110 and the second-type memory controller 210 may be used for the external device to access the first-type memory 100 and the second-type memory 200.

In some implementations, the second-type memory 200 may include a plurality of sectors. At this point, a sector may be a unit to which data is assigned in the second-type memory 200. Specifically, an available space of the second-type memory 200 may be divided into the plurality of sectors that are units to which the data is assigned, and data access in a sector unit may be performed by the second-type memory controller 210 or a compute express link (CXL) controller 40.

In some implementations, the device 1 may include the CXL controller 40. The CXL controller 40 may support the data access in the sector unit by using a CXL protocol. In other words, the data of the second-type memory 200 may be accessed as sector-level data, the CXL controller 40 may be used for processing a request or instruction from a host for accessing a memory in the device 1 (e.g., the first-type memory 100 and the second-type memory 200).

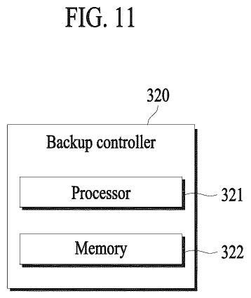

In some implementations, the backup device 30 may back up the data which is entered in at least one idle sector among the plurality of sectors into the first-type memory 100. At this point, the backup device 30 may include an idle counter 310 and a backup controller 320. In addition, unless additionally described below, an operation of the backup device 30 or the backup controller 320 may be understood as being performed by control by a processor included in the backup device 30 or the backup controller 320. Also, the operation of the backup controller 320 may be understood as being performed the backup device 30. The processor included in the backup device 30 will be described in detail with reference to FIG. 11.

In some implementations, the backup device 30 may independently include firmware to perform an operation described in the present disclosure. That is, the firmware may include pieces of predetermined code for implementing operations of the backup controller 320. The firmware may be stored in a predetermined memory in the backup device 30 to be included in the backup device 30.

Meanwhile, a portion of elements included in the device 1, which is illustrated in FIGS. 2 and 3, may be omitted depending on various example implementations. One element has been merely illustrated as a separate element for convenient description and may be a physical or logical portion of another element. Furthermore, it is apparent to those skilled in the art that an element of the device 1, which is not illustrated in FIGS. 2 and 3, and an element outside the device 1 may be further included.

Each device or module illustrated in FIGS. 1 through 3 may be connected to a network to communicate with each other. At this point, the network may be various networks such as a local area network (LAN), a wide area network (WAN), a metropolitan area network (MAN), or a global network (e.g., the Internet). For example, the network may include a wired or wireless network and include various LANs connected by the Internet.

In some implementations, the backup controller 320 may back up the data which is entered in the at least one idle sector into the first-type memory 100 based on one or more of an idle count and a status value of each of the plurality of sectors of the second-type memory 200. For example, the idle counter 310 may store one or more of the idle count and the status value of each of the plurality of sectors. The backup controller 320 may monitor the idle counter 310 or monitor the idle count and the status value of each of the plurality of sectors, which are stored in the idle counter 310. As a result of monitoring, the backup controller 320 may back up the data which is entered in the at least one idle sector into the first-type memory 200 based on the idle count and the status value of each of the plurality of sectors.

In addition, data backup performed by the backup device 30 or the backup controller 320 may be an operation of temporarily duplicating the data in advance and storing the data in another memory in order to prevent a loss of the data in a memory when an event such as non-volatile memory express (NVMe) shutdown notification, CXL global persistent flush (GPF), and a power shutdown occurs.

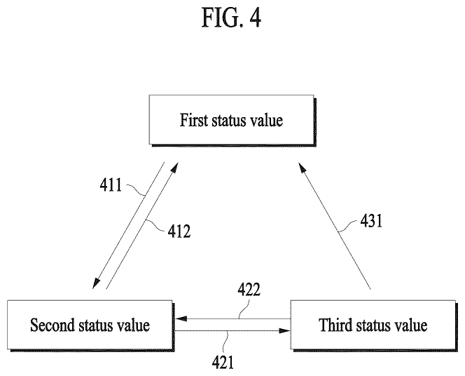

FIG. 4 is a diagram of an example of a status value of a sector.

In some implementations, each of a plurality of sectors may have an idle count and the status value. At this point, the status value of each of the plurality of sectors may be determined based on at least one of the idle count of each of the plurality of sectors and whether data is entered for each of the plurality of sectors.

The idle count is an index indicating a time that elapses since an actual task, namely, entering the data is not performed while a corresponding sector is available. For example, a unit count of the idle count may be increased at intervals of a counter period. More specifically, the unit count of the idle count may be increased at intervals of a unit time. Hereinafter, the counter period may be referred to as a cycle. For example, when five counter periods elapse, five cycles may elapse. The present disclosure will be described under an assumption that the unit count is 1.

In an example implementation, the status value may include a first status value, a second status value, and a third status value.

As an example, the first status value may correspond to a status in which the data is not entered in the sector. For example, the status in which the data is not entered in the sector may be a state in which the actual task, namely, entering the data is not performed in the sector. However, as another example, in the status in which the data is not entered in the sector may be a status in which the data may be newly entered in the sector. More specifically, the state in which the data is not entered in the sector may include a status in which any data is not entered and may include a status in which an entity managing the data recognizes that overwriting is allowed in the sector even if identifiable data has been entered in the sector.

As an example, the second status value may correspond to a status in which the data is entered in the sector. For example, the status in which the data is entered in the sector may be a status in which the actual task, namely, entering the data is performed in the sector. Specifically, the status in which the data is entered in the sector may be a status in which the data is assigned to the sector according to an instruction, from a host, on a data entering operation.

As an example, the third status value may correspond to a status in which the data in the sector is backed up into a first-type memory. For example, the status in which the data in the sector is backed up into the first-type memory may be a status in which the data entered in the sector is backed up into the first-type memory by a backup controller when the sector is identified as an idle sector as described below.

In some implementations, the status value of a sector having the first status value may be set to the second status value in response to the data being entered in the sector, which is represented by reference numeral 411. Hereinafter, a sector having the second value may be defined as an active sector.

In some implementations, the status value of the active sector having the second status value may be set to the third status value in response to the data in the active sector being backed up into the first-type memory, which is represented by reference numeral 421. At this point, the status value of a sector having the third status value may be set to the second status value in response to new data being entered in the sector, which is represented by reference numeral 422. In other words, the active sector may a sector in which the data not backed up is entered.

In some implementations, the status value of the sector having the second status value may be set to the first status value in response to the data in the sector being sanitized, which is represented by reference numeral 412. Similarly, the status value of the sector having the third status value may be set to the first status value in response to the data in the sector being sanitized, which is represented by reference numeral 431. At this point, sanitization of the data may be an operation distinguished from erasure of the data and may be a task of completely deleting the data, not simply deleting or overwriting the data, so that the data is not recoverable. However, the status value of a sector having the second status value or the third status value may be set to the first status value in response to the data in the sector being erased. This is because a first status may not be a status in which any data is not necessarily entered as described above.

Hereinafter, a method of the backup controller backing up the data which is entered in the active sector having the second status value into the first-type memory will be described in detail. Hereinafter, an operation performed by a processor included in the backup controller or a backup device.

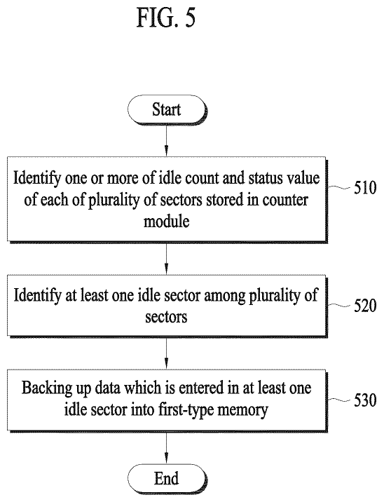

FIG. 5 is a flowchart illustrating an example of a data backup method.

Referring to FIG. 5, in operation 510, a processor may identify one or more of an idle count and a status value of each of a plurality of sectors stored in a counter module. For example, a processor of a backup controller may identify one or more of the idle count and the status value of each of the plurality of sectors stored in the counter module.

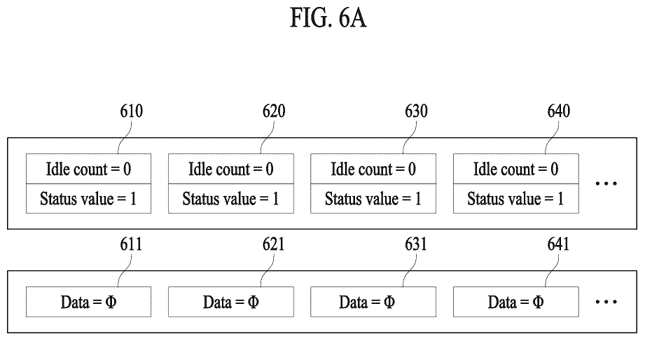

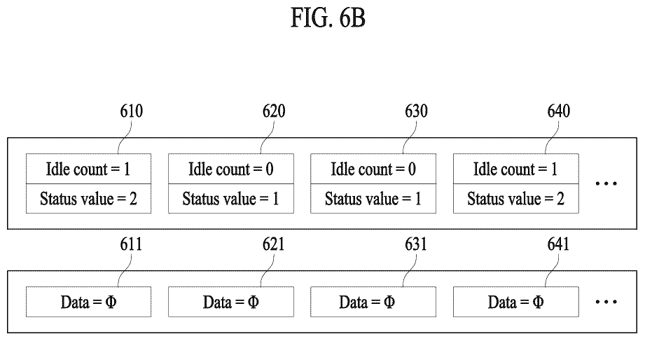

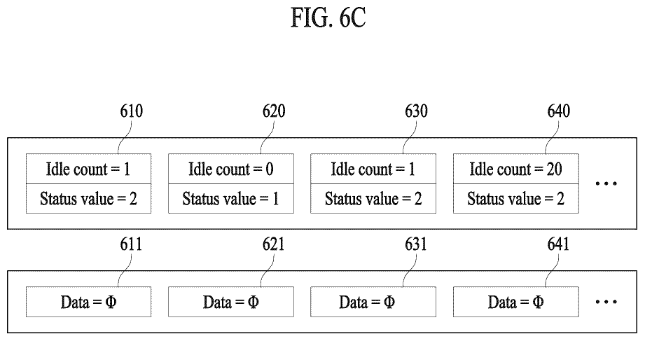

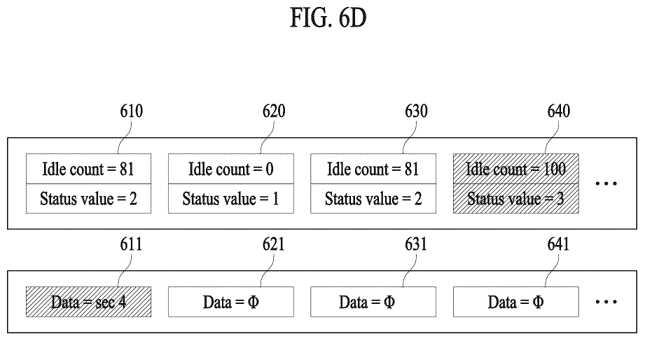

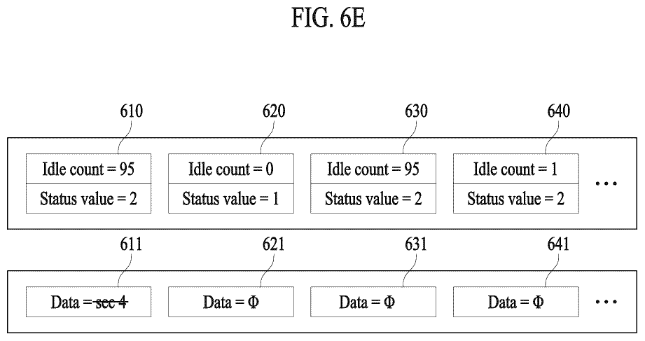

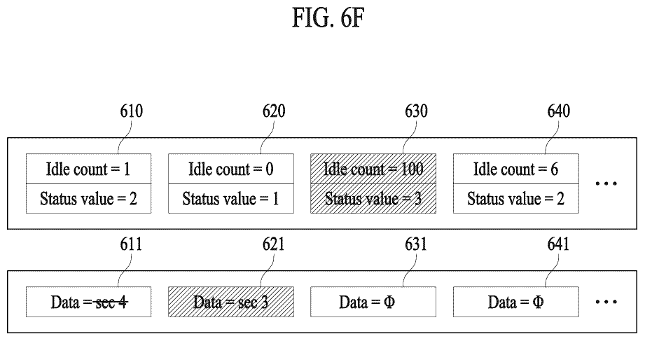

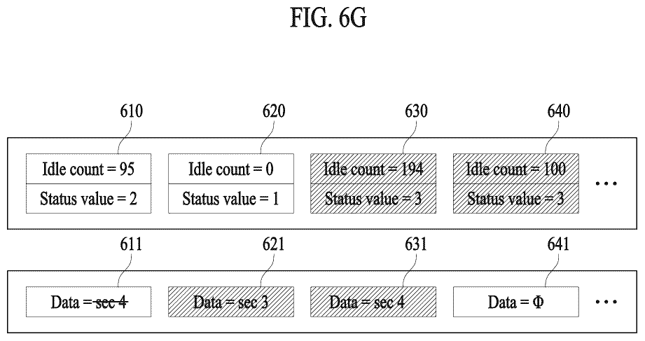

FIGS. 6A, 6B, 6C, 6D, 6E, 6F, and 6G are diagrams describing an example of an operation performed by a data storage device.

Referring to FIG. 6A, a processor may identify one or more of an idle count and a status value of each of a plurality of sectors 610 to 640. FIGS. 6A through 6G illustrate that the plurality of sectors 610 to 640 are a first sector 610, a second sector 620, a third sector 630, and a fourth sector 640 for convenient description. However, the number of the plurality of sectors 610 to 640 included in a second-type memory may not be limited to four and have a random number.

In some implementations, the processor may identify idle counts of the first sector 610 to the fourth sector 640 as 0. In addition, the processor may identify status values of the first sector 610 to the fourth sector 640 as a first status value. At this point, the idle count and the status value of each of the plurality of sectors 610 to 640 may be stored in an idle counter, and the processor may identify one or more of the idle count and the status value of each of the plurality of sectors 610 to 640 by monitoring the idle counter.

Meanwhile, a first-type memory may have a plurality of logical addresses 611 to 641. For example, a logical address of the first-type memory may be a logical page number (LPN). The LPN is a logical address in which data is stored, and the LPN is mapped to a physical page number (PPN) and used to manage a place in which the data is actually stored. As an example, the plurality of logical addresses 611 to 641 of the first-type memory may be an index that divides and indicates an area for storage (e.g., backup) by the first-type memory. FIGS. 6A through 6G illustrate that the plurality of addresses 611 to 641 are a first address 611, a second address 621, a third address 631, and a fourth address 641 for convenient description. However, the number of the plurality of sectors 611 to 641 included in the first-type memory may not be limited to four and have a random number.

Referring to FIG. 6B, it may be identified that as the data is entered in the first sector 610 and the fourth sector 640, status values of the first sector 610 and the fourth sector 640 are set to a second status value. In addition, it may be identified that as the status values of the first sector 610 and the fourth sector 640 are set to the second status value, idle counts thereof are increased by 1 that is a unit count as a counter period elapses.

In some implementations, in response to the data being entered in a target sector having the second status value, the idle count of the target sector may be initialized. Referring to the fourth sector 640 of FIG. 6C, 19 cycles of counter periods have elapses from a time point of FIG. 6B. However, it may be identified that the idle count of the first sector 610 is initialized as the data is entered in the first sector 610 having the second status value. In addition, at the same time, it may be identified that the status value of the third sector 630 is set to the second status value as the data is entered in the third sector 630.

Referring back to FIG. 5, in operation 520, the processor may identify at least one idle sector among the plurality of sectors.

In some implementations, the processor may identify the idle count of the target sector having the second status value among the plurality of sectors. For example, referring to FIG. 6C, the processor may identify, as the first sector 610, the second sector 620, and the fourth sector 640, the target sector having the second status value among the plurality of sectors 610 to 640.

In some implementations, the processor may identify the target sector as the idle sector when the identified idle count is greater than or equal to a threshold value.

Referring to FIG. 6D, the plurality of sectors 610 to 640 at a time point at which 80 cycles of counter periods elapse from a time point of FIG. 6C are illustrated. For example, when the threshold value is 100 counts, the processor may identify, as the idle sector, the fourth sector 640 of which the idle count is greater than or equal to 100 counts.

That is, in some implementations, the processor may identify, as the idle sector, a sector of which the idle count is greater than or equal to the threshold value among sectors having the second status value. In other words, the idle sector may be the sector of which the idle count is greater than or equal to the threshold value among the sectors having the second status value.

Referring back to FIG. 5, in operation 530, the processor may back up data entered in the at least one idle sector into the first-type memory.

Specifically, in some implementations, the processor may back up the data which is stored in the idle sector into the first-type memory in response to the idle sector being identified based on one or more of the idle count and the status value.

In an example of FIG. 6D, the processor may back up the data which is stored in the fourth sector 640 into the first-type memory in response to the fourth sector 640 being identified as the idle sector. Accordingly, it may be identified that a memory of the fourth sector 640 is backed up into the first address 611 of the first-type memory. Also, according to the above-described example implementations, it may be identified that the status value of the fourth sector 640 is set to a third status value.

Referring to FIG. 6E, the plurality of sectors 610 to 640 at a time point at which 14 cycles of counter periods elapse from a time point of FIG. 6D are illustrated. In FIG. 6E, it may be identified that in response to new data being entered in the fourth sector 640 having the third status value, the idle count of the fourth sector 640 is initialized, the status value of the fourth sector 640 is set to the second status value, and the data which is previously backed up for the fourth sector 640 is erased (or sanitized) from the first address 611. As such, in some implementations, when new data is entered in a sector corresponding to the data which is backed up into a predetermined logical address in the first-type memory, the processor may delete the data which is backed up into the predetermined logical address.

Referring to FIG. 6F, the plurality of sectors 610 to 640 at a time point at which 5 cycles of counter periods elapse from a time point of FIG. 6D are illustrated. In FIG. 6F, it may be identified that new data is entered in the first sector 610. Also, the processor may identify the third sector as the idle sector in response to the idle count of the third sector 630 being greater than or equal to the threshold value, back up the data which is stored in the third sector 630 into the second address 621 of the first-type memory, initialize the idle count of the third sector 630, and set the status value of the third sector 630 to the third status value.

Referring to FIG. 6G, the plurality of sectors 610 to 640 at a time point at which 94 cycles of counter periods elapse from a time point of FIG. 6F are illustrated. In example implementations of FIG. 6F, the processor may back up the data which is entered in the fourth sector 640 which has the second status value and of which the idle count is greater than or equal to the threshold value into the third address 631 of the first-type memory.

As such, in some implementations, the processor may sequentially back up the data which is entered in the at least one idle sector into the plurality of logical addresses 611 to 641 of the first-type memory. In addition, as such in the above-described example implementations, the data entered in each of the third sector 630 and the fourth sector 640 may be sequentially backed up in the plurality of logical addresses 611 to 641 of the first-type memory. Through this, the data of the third sector 630 and the data of the fourth sector 640 may be backed up into the second address 621 and the third address 631, respectively.

In some implementations, the processor may back up the data entered in a sector having the second status value among the plurality of sectors 610 to 640 when a whole backup event is identified. That is, in example implementations of FIG. 6G, the processor may back up the data which is entered in the first sector 610 having the second status value into the fourth address 641 of the first-type memory.

According to example implementations of the present disclosure, the idle sector in which entering new data is not performed for a predetermined time may be identified before the whole backup event occurs, and the data which is entered in the idle sector may be backed up in advance. Through this, an amount of the data which requires backup and a time required for the backup may be decreased when the whole backup event occurs.

Meanwhile, the whole backup event may include at least one of an NVMe shutdown notification event, a CXL GPF event, and a power shutdown event. The NVMe shutdown notification event and the CXL GPF event may be events that are received from a host and flush the data which is stored in the second-type memory to the first-type memory.

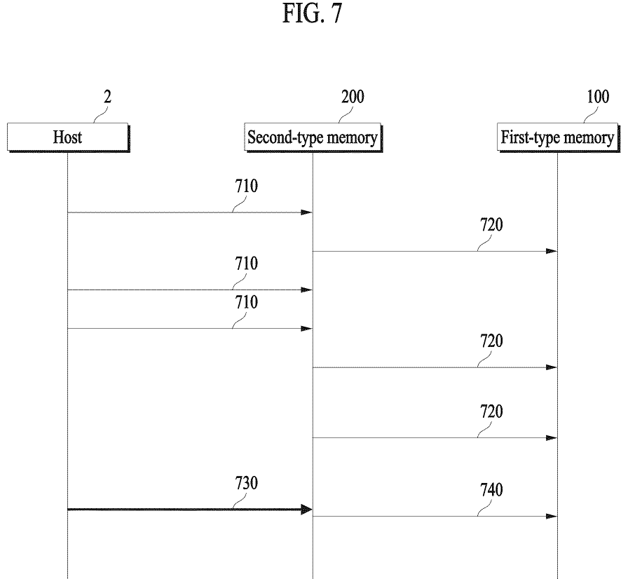

FIG. 7 is a diagram for describing an example of an operation performed by a data storage system.

Referring to FIG. 7, in operation 710, the host 2 may transmit an instruction on a data entering operation for the second-type memory 200 or a second-type memory module. At this point, in operation 720, at least a portion of data entered in a plurality of sectors of the second-type memory 200 may be backed up into the first-type memory 100 based on an idle count and a status value of each of the plurality of sectors. Specifically, in operation 720, the data which is entered in a sector that corresponds to a second status value and of which the idle count is greater than or equal to a threshold value may be backed up into the first-type memory 100.

In some implementations, in operation 730, the host 2 may transmit an instruction on a whole backup event for the second-type memory 200 or the second-type memory module. At this point, in operation 740, all the data entered in the sector corresponding to the second status value, of the data entered in the plurality of sectors of the second-type memory 200, may be backed up into the first-type memory 100.

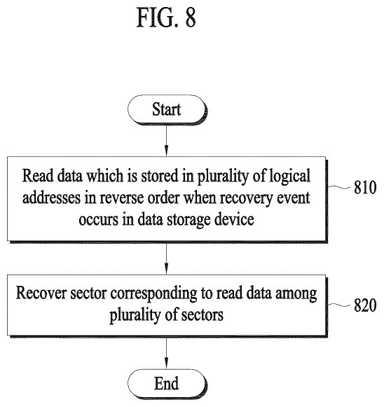

FIG. 8 is a diagram for describing an example of an operation performed by a data storage device.

Referring to FIG. 8, in operation 810, when a recovery event occurs in the data storage device, a processor may read data stored in a plurality of logical addresses of a first-type memory in reverse order.

For example, under an assumption that the data is stored in the second address 621 and the third address 631 of a first-type memory as described above in FIG. 6G, when the recovery event occurs, the processor may read the data stored in the third address 631 of the first-type memory and read the data stored in the second address 621.

In operation 820, the processor may recover a sector corresponding to the read data among a plurality of sectors. At this point, a status value of the recovered sector may be set to a second status value.

For example, similarly to the above-described example implementation, in a case of FIG. 6G, the processor may recover the fourth sector 640 which is a sector corresponding to the data stored in the third address 631 and recover the third sector 630 which is a sector corresponding to the data stored in the second address 621.

In example implementations of FIG. 8, the processor is described as reading the plurality of logical addresses of the first-type memory in reverse order and then recovering the read data into a second-type memory. However, the processor may perform reading the plurality of logical addresses of the first-type memory in reverse order and restoring at the same time. In other words, for example, in the case of FIG. 6, the processor may read the data stored in the third address 631, recover the data into the third sector 630 which is the sector corresponding to the data stored in the third address 631, read the data stored in the second address 621 in reverse order, and recover the data into the second sector 620 which is the sector corresponding to the data stored in the second address 621.

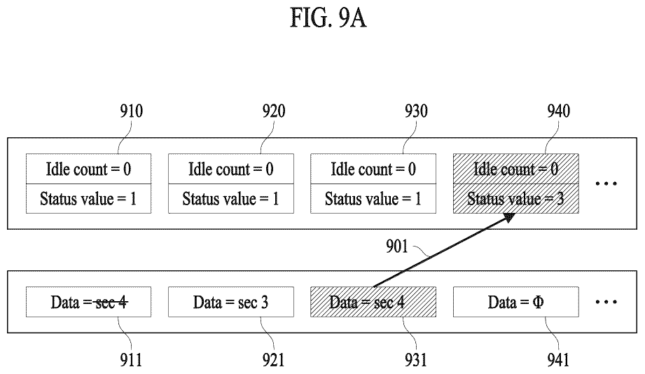

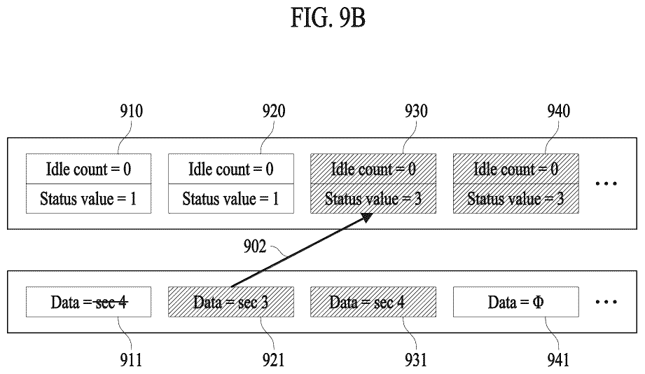

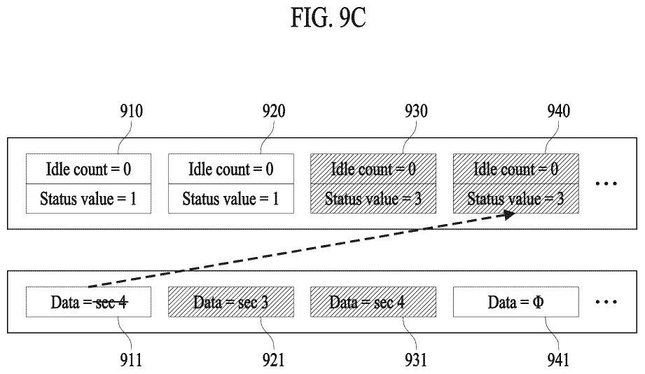

Hereinafter, an example with reference to FIGS. 9A through 9C will be described in detail.

FIGS. 9A, 9B, and 9C are diagrams describing an example of an operation performed by a data storage device.

In some implementations, a recovery event may occur in the data storage device. At this point, a processor may read, in reverse order, and recover data stored in a plurality of logical address 911 to 941 of a first-type memory.

For example, referring to FIG. 9A, the processor may read the data which is stored in a third address 931 among the plurality of logical address 911 to 941 of the first-type memory and recover the data into a fourth sector 940 of a second-type memory, which corresponds to the data stored in the third address 931.

Then, referring to FIG. 9B, the processor may read the data which is stored in a second address 921 among the plurality of logical address 911 to 941 of the first-type memory in reverse order from the third address 931 and recover the data into a third sector 930 of the second-type memory, which corresponds to the data stored in the second address 921.

In contrast, referring to FIG. 9C, the processor may read the data which is stored in a first address 911 among the plurality of logical address 911 to 941 of the first-type memory based on the second address 921. However, at this point, since the data stored in the first address 911 is the data of the fourth sector 940, which is already recovered, the data may not be recovered into the fourth sector 940 of the second-type memory, which corresponds to the data previously stored in the first address 911.

In some implementations, when the processor reads, in reverse order, and recovers the data stored in the plurality of logical address 911 to 941 of the first-type memory, and when the number of recovered sectors is equal to the number of all sectors except a sector that has had a first status value before a whole backup event occurs, the processor may end the above-described recovery operation.

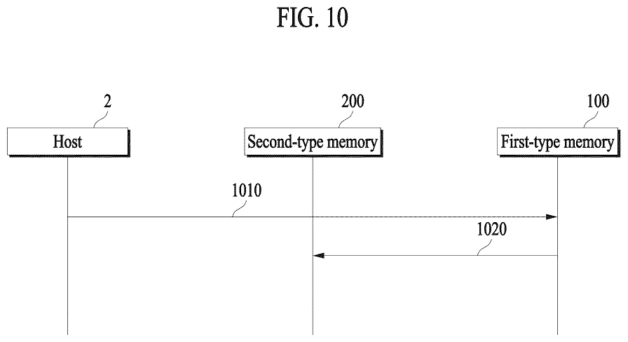

FIG. 10 is a diagram for describing an example of an operation performed by a data storage system.

Referring to FIG. 10, in operation 1010, the host 2 may transmit an instruction on a data recovery operation for the first-type memory 100 or a first-type memory module. At this point, in operation 1020, data stored in a plurality of logical addresses of the first-type memory 100 may be recovered into the second-type memory 200. Specifically, in operation 1020, the data stored in the plurality of logical addresses of the first-type memory 100 may be read in reverse order and recovered into the second-type memory 200.

FIG. 11 is a block diagram illustrating an example of a backup controller.

Referring to FIG. 11, the backup controller 320 may include a processor 321 and a memory 322. In the backup controller 320 of FIG. 11, only elements associated with the present example implementation are illustrated. Thus, those skilled in the art may understand that other elements in general use in addition to the elements illustrated in FIG. 11 may be further included.

FIG. 11 illustrates one single processor 321, but the backup controller 320 may include any number of processors. Each processor may be a single-core process or a multi-core processor, may implement a reduced instruction set computer (RISC) architecture or a complex instruction set computer (CISC) architecture, and may be mixed in a desired combination.

The memory 322 may be hardware that stores a variety of data processed in the backup controller 320 and may store a program for processing and control by the processor 321.

The memory 322 may include a random access memory (RAM) such as a dynamic random access memory (DRAM) and a static random access memory (SRAM), a read-only memory (ROM), an electrically erasable programmable read-only memory (EEPROM), a compact disc (CD)-ROM, Blu-ray or another optical disc storage, a hard disk drive (HDD), a solid state drive (SSD), or a flash memory, separately from a first-type memory and a second-type memory.

The processor 321 may control overall operations of the backup controller 320. For example, the processor 321 may control an input part, a display, a communication part, the memory 322, and the like overall by executing programs stored in the memory 322. The processor 321 may control an operation of the backup controller 320 by executing the programs stored in the memory 322.

The processor 321 may control at least a portion of an operation of the device described above in FIGS. 1 through 10.

The processor 321 may be implemented by using at least one of application specific integrated circuit (ASIC), digital signal processor (DSP), digital signal processing device (DSPD), programmable logic device (PLD), field programmable gate array (FPGA), controller, micro-controller, microprocessor, and an electrical unit for performing another function.

In an example implementation, the backup controller 320 may be a server. The sever may be implemented with a computer device or a plurality of computer devices that provide an instruction, code, a file, content, a service, or the like through communication via a network.

Meanwhile, the backup controller 320 may further include the communication part. The communication part may include one or more elements for wired/wireless communication with an external sever or an external device. For example, the communication part may include at least one of a local area communication part, a mobile communication part, and a broadcast receiving part.

The electronic apparatus according to the above-described example implementations may include a processor, a memory that stores and executes program data, a permanent storage such as a disk drive, a communication port for communicating with an external device, and a user interface device such as a touch panel, a key, and a button. Methods implemented by software modules or algorithms may be stored in a computer-readable recording medium as computer-readable code or program instructions executable in the processor. Here, the computer-readable recording medium may include a magnetic storage medium (e.g., a read-only memory (ROM), a random-access memory (RAM), a floppy disk, a hard disk, or the like), an optical reading medium (e.g., a CD-ROM or a digital versatile disc (DVD)), or the like. The computer-readable recording medium may be dispersed to computer systems connected by a network so that computer-readable codes may be stored and executed in a dispersed manner. The medium may be read by a computer, stored in the memory, and executed by the processor.

The present example implementations may be represented by functional blocks and various processing steps. These functional blocks may be implemented by various numbers of hardware and/or software configurations that execute specific functions. For example, the present example implementations may adopt integrated circuit configurations such as a memory, a processor, a logic circuit, and a look-up table that may execute various functions by control of one or more microprocessors or other control devices. Similarly to that elements may be executed by software programming or software elements, the present example implementations may be implemented by programming or scripting languages such as C, C++, Java, and assembler language, including various algorithms implemented by combinations of data structures, processes, routines, or of other programming configurations. Functional aspects may be implemented by algorithms executed by one or more processors. In addition, the present example implementations may adopt the related art for electronic environment setting, signal processing, and/or data processing, for example. The terms “mechanism”, “element”, “means”, and “configuration” may be widely used and are not limited to mechanical and physical components. These terms may include meaning of a series of routines of software in association with a processor.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

The above-described implementations are merely examples and other implementations may be implemented within the scope of the following claims.

What is claimed is:

1. A data storage device comprising:
a first-type memory;
a second-type memory comprising a plurality of sectors; and
a processor configured to back up data from at least one idle sector of the plurality of sectors into the first-type memory.

2. The data storage device of claim 1, wherein the processor is configured to back up the data into the first-type memory based on at least one of an idle count or a status value of each sector of the plurality of sectors.

3. The data storage device of claim 2, wherein the status value of a sector is based on at least one of the idle count of the sector or whether the data is stored in the sector.

4. The data storage device of claim 3, wherein a unit count of the idle count of each sector of the plurality of sectors is increased at intervals of a counter period.

5. The data storage device of claim 3, wherein the status value of the sector includes:
a first status value corresponding to a first status in which the data is not stored in the sector;
a second status value corresponding to a second status in which the data is stored in the sector; or
a third status value corresponding to a third status in which the data in the sector is backed up into the first-type memory, and
wherein the status value of an active sector having the second status value is set to the third status value based on the data in the active sector being backed up into the first-type memory.

6. The data storage device of claim 5, wherein, based on the data being stored in a target sector having the second status value, the idle count of the target sector is configured to be initialized.

7. The data storage device of claim 5, wherein the at least one idle sector is a sector of which the idle count is greater than or equal to a threshold value among a second plurality of sectors having the second status value.

8. The data storage device of claim 3, wherein the processor is configured to back up the data into the first-type memory based on the at least one idle sector being identified, the at least one idle sector being identified based on the at least one of the idle count or the status value of the at least one idle sector.

9. The data storage device of claim 5, wherein the processor is configured to
identify a whole backup event, and
back up the data into the first-type memory based on the whole backup event, the data being stored in a sector having the second status value.

10. The data storage device of claim 9, wherein the whole backup event includes at least one of:
a non-volatile memory express shutdown notification event;
a compute express link global persistent flush event; or
a power shutdown event.

11. The data storage device of claim 2, wherein the processor is configured to:
sequentially back up the data into a plurality of logical addresses of the first-type memory; and
read, based on a recovery event, the data in reverse order to recover a sector corresponding to the read data among the plurality of sectors, and
wherein the status value of the recovered sector is configured to be set to a second status value.

12. The data storage device of claim 1, wherein the first-type memory is a non-volatile memory, and
wherein the second-type memory is a volatile memory.

13. A data backup method by a data storage device, the data backup method comprising:
identifying at least one of an idle count or a status value of each sector of a plurality of sectors of a second-type memory, the at least one of the idle count or the status value being stored in a counter circuit;
identifying at least one idle sector among the plurality of sectors; and
backing up data from the at least one idle sector into a first-type memory.

14. The data backup method of claim 13, wherein the status value of a sector includes:
a first status value corresponding to a first status in which the data is not stored in the sector;
a second status value corresponding to a second status in which the data is stored in the sector; or
a third status value corresponding to a third status in which the data in the sector is backed up into the first-type memory.

15. The data backup method of claim 14, comprising setting the status value of an active sector having the second status value to the third status value based on the data in the active sector being backed up into the first-type memory.

16. The data backup method of claim 14, comprising initializing the idle count of a target sector based on the data being stored in the target sector having the second status value.

17. The data backup method of claim 14, wherein identifying the at least one idle sector comprises:
identifying the idle count of a target sector having the second status value among the plurality of sectors; and
identifying the target sector as the idle sector based on the identified idle count being greater than or equal to a threshold value.

18. The data backup method of claim 14, wherein backing up the data comprises backing up the data into the first-type memory based on identification of a whole backup event, the data being stored in a sector having the second status value among the plurality of sectors.

19. The data backup method of claim 13, the method comprising:
sequentially backing up the data into a plurality of logical addresses of the first-type memory;
reading the data in reverse order based on a recovery event in the data storage device; and
recovering a sector corresponding to the read data among the plurality of sectors, and
wherein the status value of the recovered sector is set to a second status value.

20. A data storage system comprising:
a first-type memory;
a second-type memory comprising a plurality of sectors;
a host configured to receive a first instruction on at least one of a data entering operation, a data reading operation, a whole backup operation, or a data recovery operation; and
a backup controller configured to back up the data based on at least one of an idle count or a status value of each sector of the plurality of sectors, the data being stored in at least one sector of the plurality of sectors,
wherein the status value is determined based on a second instruction on at least one of the data entering operation or the whole backup operation.
